(19) United States
(12) Patent Application Publication
(10) Pub. No.: US 2019/0228419 A1
(43) Pub. Date: Jul. 25, 2019

(54) DYNAMIC SELF-LEARNING SYSTEM FOR AUTOMATICALLY CREATING NEW RULES FOR DETECTING ORGANIZATIONAL FRAUD

(71) Applicant: Surveillens, Inc., New York, NY (US)

(72) Inventor: Vijay Sampath, New York, NY (US)

(21) Appl. No.: 16/306,805

(22) PCT Filed: Jun. 2, 2017
(86) PCT No.: PCT/US17/35614

§ 371 Date: Dec. 3, 2018

Related U.S. Application Data
(60) Provisional application No. 62/344,932, filed on Jun. 2, 2016.

(51) Int. Cl. G06Q 30/00; G06K 9/62; G06N 20/00

(52) U.S. Cl. CPC G06Q 30/0185; G06N 20/00; G06K 9/6215; G06K 9/6263

(57) ABSTRACT

A fraud detection system that applies scoring models to process transactions by scoring them and sidelines potential fraudulent transactions is provided. Those transactions which are flagged by this first process are then further processed to reduce false positives by scoring them via a second model. Those meeting a predetermined threshold score are then sidelined for further review. This iterative process recalibrates the parameters underlying the scores over time. These parameters are fed into an algorithmic model. Those transactions sidelined after undergoing the aforementioned models are then autonomously processed by a similarity matching algorithm. In such cases, where a transaction has been manually cleared as a false positive previously, similar transactions are given the benefit of the prior clearance. Less benefit is accorded to similar transactions with the passage of time. The fraud detection system predicts the probability of high risk fraudulent transactions. Models are created using supervised machine learning.

### FIELD OF THE INVENTION

The present invention is directed to a self-learning system and method for detecting fraudulent transactions by analyzing data from disparate sources and autonomously learning and improving the detection ability and results quality of the system.

### BACKGROUND

Compliance with governmental guidelines and regulations to prevent fraudulent transactions impose significant burdens on corporations. Adding to these burdens are additional internal standards to prevent fraudulent transactions which could result in monetary damage to the organization. These burdens on corporations are both financial and reputational.

Monitoring transactions for the possibility of illicit or illegal activity is a difficult task. The complexity of modern financial transactions coupled with the volume of transactions makes monitoring by human personnel impossible. Typical solutions involve the use of computer systems programmed to detect suspicious transactions coupled with human review. However, these computerized systems often generate significant volumes of false positives that need to be manually cleared. Reducing the stringency of the computerized system is an imperfect solution as it results in fraudulent transactions escaping detection along with the false positives and such modifications must be manually entered to the system.

For example, many fraud detection products produce a large number of false positive transactions identified by rules based fraud detection software which makes the process cumbersome, costly and ineffective. Other fraud detection software caters to either structured data or unstructured data, thus not facilitating the use of both data types simultaneously. Often, current fraud detection software only tests transactions for fraud and does not facilitate testing of fraud risk on a holistic or modular basis. Lastly, email review software uses key word searches, concept clustering and predictive coding techniques but fails to include high risk transaction data in those searches or techniques.

What is needed is a method and system that allows for autonomous modification of the system in response to the activity of the human monitors utilizing the system. The benefit of such an approach is that the number of transactions submitted for manual investigation is dramatically reduced and the rate of false positives is very low.

### SUMMARY OF THE INVENTION

According to an aspect of the present invention, a fraud detection system applies scoring models to process transactions by scoring them and sidelines potential fraudulent transactions. Those transactions which are flagged by this first process are then further processed to reduce false positives by scoring them via a second model. Those meeting a predetermined threshold score are then sidelined for further review. This iterative process recalibrates the parameters underlying the scores over time. These parameters are fed into an algorithmic model.

In another aspect of the present invention, those transactions sidelined after undergoing the aforementioned models are then autonomously processed by a similarity matching algorithm. In such cases, where a transaction has been manually cleared as a false positive previously, similar transactions are given the benefit of the prior clearance.

In yet another aspect of the present invention less benefit is accorded to similar transactions with the passage of time.

In another aspect of the present invention, the fraud detection system will predict the probability of high risk fraudulent transactions.

In a further aspect of the present invention, the models are created using supervised machine learning.

### BRIEF DESCRIPTION OF THE DRAWINGS

FIG. 1 is a diagram of the technical specifications of the system architecture of an embodiment of the present invention.

FIG. 2 is a flowchart depicting the processing of transactions in an embodiment of the present invention.

FIG. 3 is a flowchart depicting the internal architecture of the Data Processing Engine Architecture in an embodiment of the present invention.

FIG. 4 is a flowchart depicting the components of the Data Processing Engine Architecture in an embodiment of the present invention.

FIG. 5 is a flowchart showing the Portal Architecture in an embodiment of the present invention.

FIG. 6 is a flowchart showing the Deployment Architecture in an embodiment of the present invention.

FIG. 7 is a flowchart showing the data flow and integration in an embodiment of the present invention.

FIG. 8 is a flowchart showing the Reporting-System Architecture in an embodiment of the present invention.

FIGS. 9A and 9B are high-level schematic diagrams of a parser design for the platform architecture for adapting the underlying data structures to other types of financial transactions (e.g., banking transactions).

FIG. 10 is flowchart depicting Key Risk Indicator (KRI) creation in by an administrator in an embodiment of the present invention.

FIG. 11 is a flowchart depicting Key Risk Indicator (KRI) creation in by a compliance analyst in an embodiment of the present invention.

FIG. 12 is a flowchart depicting a due diligence process workflow in an embodiment of the present invention.

FIG. 13 is a flowchart depicting a transaction monitoring module for a level 1 analyst in an embodiment of the present invention.

FIG. 14 is a flowchart depicting a transaction monitoring module for a level 2 analyst in an embodiment of the present invention.

FIG. 15 is a high-level schematic diagram of an embodiment of the present invention for reducing false positives.

FIG. 16 is a high-level schematic diagram of an embodiment of the present invention for identifying false negatives.

FIG. 17 is a flow chart depicting an integrated framework for how the machine learning process will operate.

FIGS. 18A and 18B is a flow chart of the analysis process of an embodiment of the present invention.

FIGS. 19A-19C is a flow chart of the analysis process of an embodiment of the present invention.

FIGS. 20A and 20B is a flow chart of the analysis process of an embodiment of the present invention.

FIGS. 21A-21E is a flow chart of the analysis process of an embodiment of the present invention.

### DETAILED DESCRIPTION OF THE INVENTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the invention may be practiced without these specific details. In other instances, well-known methods, procedures, components, circuits and network have not been described in detail so as to not unnecessarily obscure aspects of the embodiments.

The present invention is directed, inter alia, to provision of a data analytics and warehousing platform or system that uses big data capabilities to analyze, measure and report various compliance risks in an organization. Embodiments of the platform run on a real-time or batch basis depending on user selected parameters. The platform utilizes both structured and unstructured data.

By way of overview, in a platform of the invention there are the following modules: Risk Assessment; Due Diligence; Transaction and Email Monitoring; Internal Controls; Investigations/Case Management; Policies and Procedures; Training and Certification; and Reporting. Each module, except for Reporting, has its own associated workflow. As discussed herein, the Risk Assessment, Due Diligence, Transaction Monitoring, and Internal Controls modules have risk algorithms/rules that identify organizational fraud including bribery and corruption risks present in an organization.

In accordance with embodiments of the present invention, techniques are described for reducing false positives after transaction-based rules have been run against a financial database to identify unusual transactions. By way of definition, a false positive is an error that arises when a rule/analytic incorrectly identifies a particular transaction as risky in terms of possible fraudulent payments. Suspect transactions are identified based on fraud data analytics through a rules engine built into the system. These analytics show significant patterns or relationships present among the data. Techniques utilized include running clustering and regression models using statistical packages that are part of the system. These techniques automatically group transactions based on their probability of being fraudulent. A probability threshold is set manually based on prior experience in detecting fraud and is a value between 0 and 1. A high probability will indicate higher probability of fraud. Those transactions that have the probability of fraud beyond the probability threshold will be selected for further manual review. Those transactions that pass the manual review are identified as legitimate transactions and are marked as false positives and stored in the platform. The system then learns new patterns from these false positive transactions and dynamically create new rules by applying clustering techniques to the false positives. These new rules in combination with prior existing rules identify fraudulent and false positive transactions more precisely whenever newer transactions from the financial database are run, either on real-time or batch basis. Thus the system becomes progressively smarter as more transactions are run through the system. In further embodiments, techniques utilizing characteristics of high risk transactions and background information about the third parties involved in those transactions are used as inputs for conducting email review.

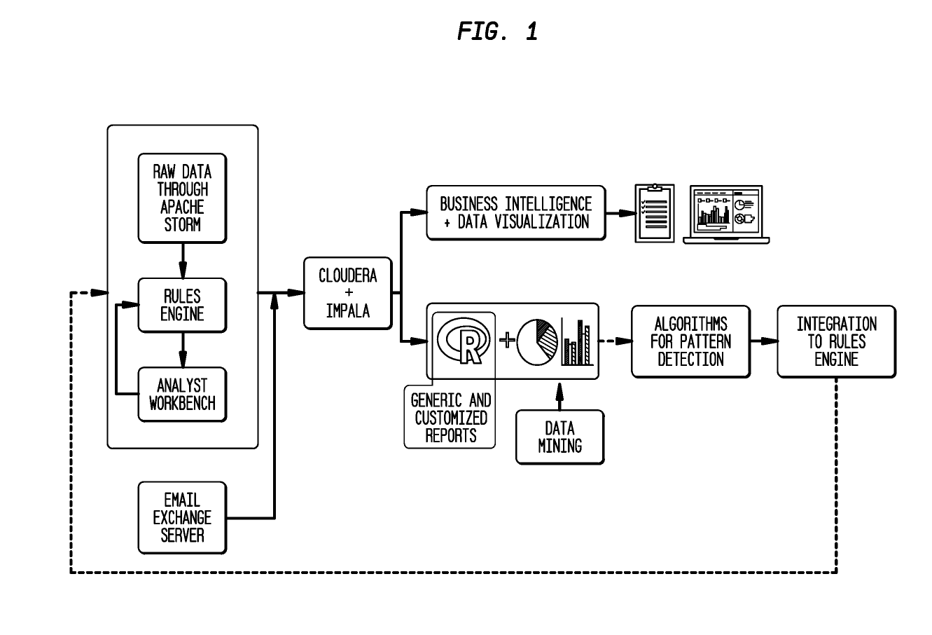

The platform is preferably resident on a networked computer, most preferably in a cloud computing or internal organization computer network. The platform has access to a database of stored transactions. Referring now to FIG. 1, in an exemplary embodiment of the system the architecture makes use of a modular software framework, for example the Hadoop Platform™ (Cloudera™ plus Impala™). Preferably, a distributed computation framework such as Apache Storm™ is integrated for processing streaming data.

Connectors are provided for business intelligence software such as Qlik™; and for statistical package such as R language code. Typically application activities are logged in real time to Hadoop. Preferably logs support data snapshot creation as of any particular date for all history dates, thereby allowing analytics to run on the current data or a historic snapshot. Security software is provided, preferably the use of transparent encryption for securing data inside the distributed file system, for example the Hadoop™ distributed file system (HDFS) on Cloudera Hadoop™. Integration of the system with security software such as Apache Sentry™ allows for secure user authentication to the distributed file system data.

Turning now to the reduction of false positives during detection of fraudulent transactions in an embodiment of the present invention, when a transaction that is identified as high risk is sidelined for investigation by an analyst, it may turn out to be false positive. The analyst will examine all the available pieces of data in order to come to the conclusion whether the transaction was legitimate or not.

The platform employs a supervised machine learning algorithm based on the analyst investigations and discovers new rules in the transactions. Building the machine learning algorithm involves a methodology of feature/attribute selection wherein appropriate features are selected. The selection will be done by subject matter experts in the fraud investigation arena. Not doing so would involve a trial and error method that can become extremely unwieldy and cumbersome because of the numerous possible combinations that can be derived from the entire feature set.

In supervised machine learning algorithms, the machine learning algorithm is given a set of inputs and the correct output for each input. Based on this information, the machine learning algorithm adjusts the weights of its mathematical equations so that the probability of predicting the correct output is the highest for new inputs. In the present context, the inputs are the sidelined transactions and the outputs are the outcomes of the manual investigation. By training the machine learning algorithm periodically with the outputs of manual investigations, the machine learning algorithm becomes smarter with time. New transactions coming into the system are subject to the machine learning algorithm which decides whether to sideline future transactions for compliance investigations. With the self-learning system, the rate of false positives will decrease over time as the system becomes smarter, thereby making the process of compliance very efficient and cost effective.

The machine learning algorithm is designed as a rule into the rules engine. This rule is built into the Apache Storm™ framework as a ‘bolt’. This particular bolt, which sits as the last bolt in the processing engine, will autonomously processes the transactions and assign probability scores for the transactions that trigger the rest of the rules engine. The weights of the mathematical equations underlying the machine learning algorithm get recalibrated every time the machine learning algorithm is updated with new data from the analyst investigations.

Those transactions that are not classified as false positive can be considered to be high risk or fraudulent transactions. Within the self-learning system, the algorithm adjusts the weights of its mathematical equation appropriately as the system sees similar high risk transactions over time. The platform thus learns fraud patterns based on the underlying high risk transactions. This predictive coding of high risk or fraudulent transactions is another aspect of the present invention.

The steps for the modelling approach for building the supervised machine learning algorithm are as follows:

A dependent variable, Risky Transaction, is preferably a dichotomous variable where the transaction is coded as 1 if it is fraudulent and 0 otherwise.

The platform has consolidated all data at the line levels (e.g., Accounts Payable (AP) Lines data) and combined it with header level data (e.g., AP Header data) so that the maximum number of possible variables are considered for analysis. These line and header level data are preferably the independent variables.

Clusters in the data based on the number of lines and amount distribution and/or based on concepts are created. Creating a cluster (or clustering or cluster analysis) involves the grouping of a set of objects (each group is called a cluster) in a way such that objects in a group are more similar to each other than objects in another group or cluster. Clustering is an iterative process of optimizing the interaction observed among multiple objects.

k-means clustering technique is applied in developing the clusters. In k-means clustering, ‘n’ observations are partitioned into ‘k’ clusters, where each observation belongs to the cluster with the nearest mean. The resulting clusters are the subject of interest for further analysis.

Classification trees are designed to find independent variables that can make a decision split of the data by dividing the data into pairs of subgroups. The chi-square splitting criteria is preferably used especially chi-squared automatic interaction detection (CHAID).

When classification trees are used, the model is preferably overfit and then scaled back to get to an optimal point by discarding redundant elements. Depending on the number of independent variables, a classification tree can be built to contain the same number of levels. Only those independent variables that are significant are retained.

Now turning to false negatives, in a similar manner to false positives, false negatives are also tackled in an embodiment of the present invention. A false negative is a transaction that the system decided was good but was later discovered as bad (e.g. fraudulent). In this case, the machine learning algorithm is built to detect similarity to a false negative transaction. For similarity detection, two transactions are compared based on a number of transaction attributes and using a metric such as cosine similarity. Preferably, instead of supervised machine learning, similar transactions are clustered whenever a false negative transaction is discovered. Preferably Hadoop algorithms are used to find the set of all transactions that are similar to the false negative. The cluster identification method is then defined as a rule so that future transactions are sidelined for analyst investigation.

In embodiments of the present invention, transactional data from a organization's financial transaction systems, such as an Enterprise Resource Planning system, is extracted through connectors on a preselected periodic basis (daily, weekly, bi-weekly, monthly, etc.) either through real-time or batch feeds. The system has prebuilt connectors for SAP, Oracle and other enterprise systems and databases. In addition to SAP and Oracle connectors, a database is built in SQL Server or MongoDBwhere the extracted transaction data are staged.

The database queries the enterprise systems and databases periodically and downloads the necessary data. Every transaction is assigned a “transaction id number” in the database. Preferably, transactions for review are separated into three different types:

Third party transactions—transactions in which third parties (vendors, suppliers, agents, etc.) are providing services or selling goods to the organization.

Customer transactions—transactions in which the organization is providing services or selling goods to customers.

General Ledger (GL) transactions—all other transactions including: Transactions between the organization and its own employees. These would typically include (i) transactions in which the employee is being reimbursed for expenses incurred on behalf of the organization (travel & entertainment expenses (T&E), for example, a business trip or meal) (ii) cash advances provided to an employee. Note: for these transactions the organization may have used a different system to capture time and expense reimbursement data. This system will then feed a monthly total to the organization's main enterprise system. If this is the case the software may extract detailed transaction data directly from the T&E system.

Gifts made by the organization to third parties or companies

Political contributions made by the organization to third parties or companies

Contributions to charity made by the organization to third parties or companies.

Once the information from the above tables and fields has been pulled into the software, the software will run the rules engine to determine if any of the rules have been violated—see table 2 for pre-built fraud rules/analytics; the application will also give users the ability to build their own business rules/analytics based on their unique business scenarios or refine current rules. These rules will be programmed into the software based on the processes surrounding the aforementioned transaction types: third party, customer, and GL. Information from the other modules will be culled or data extracted from other systems such as Customer Relationship Management, Human Resources Management Systems, Travel & Entertainment and Email (either through connectors or as flat files) before the rules are run. This data is used in the TMM process described herein.

### MODULES

Risk Assessment (RA) Module

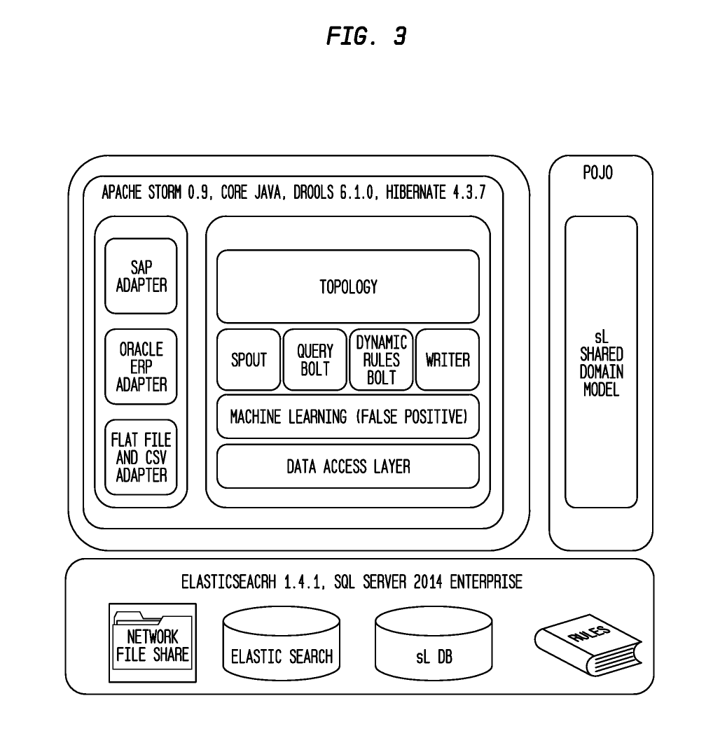

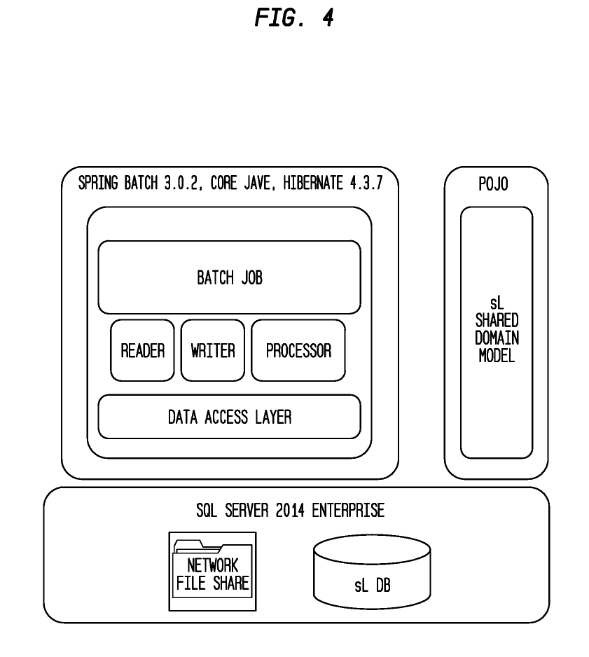

In embodiments, referring to FIGS. 3 and 4, the RA module assists in calculating the risk associated in dealing with 3rd parties with the objective of:

(1) Identify Key Risk Indicators (KRIs) related to fraud risks (e.g., bribery and corruption, pay-to-procure) facing a corporation; these risks can be classified as quantitative and qualitative factors (see examples of KRIs and related categorization in Example 2)

(2) Assign different categories to each KRI ranging from low to high; the different categories will be designated as low, medium-low, medium-high and high

(3) Assign weights to each KRI identified

(4) Calculate the composite risk score for each geographical location (by country and region) and/or business unit by multiplying each KRI category score with the respective weights; the maximum composite score is 100

(5) Compare risk of operations in different geographies and/or business units by classifying the composite risk scores in different bands: High >75%, Medium-high—51-75%, Medium-low—26-50%, Low—0-25%.

Due Diligence Module

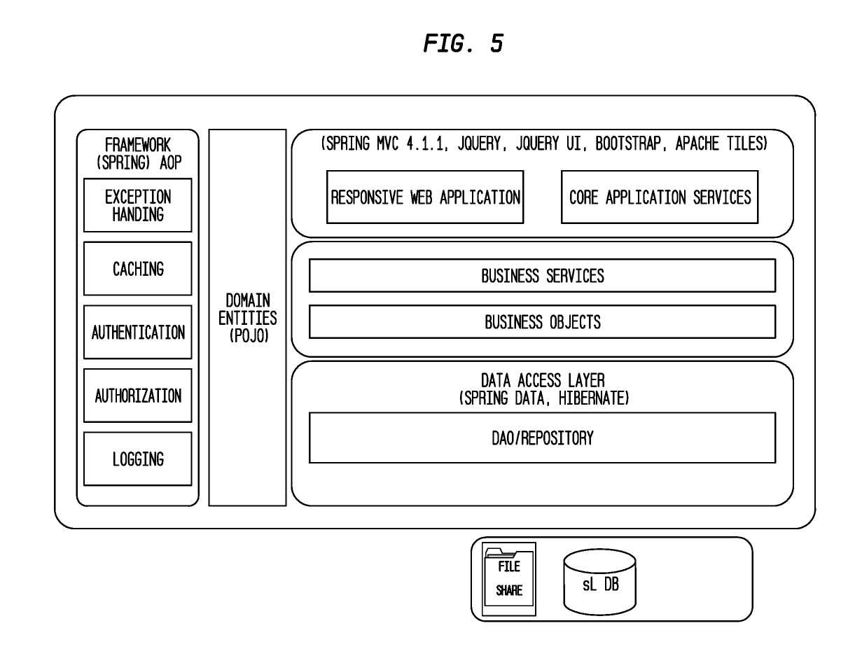

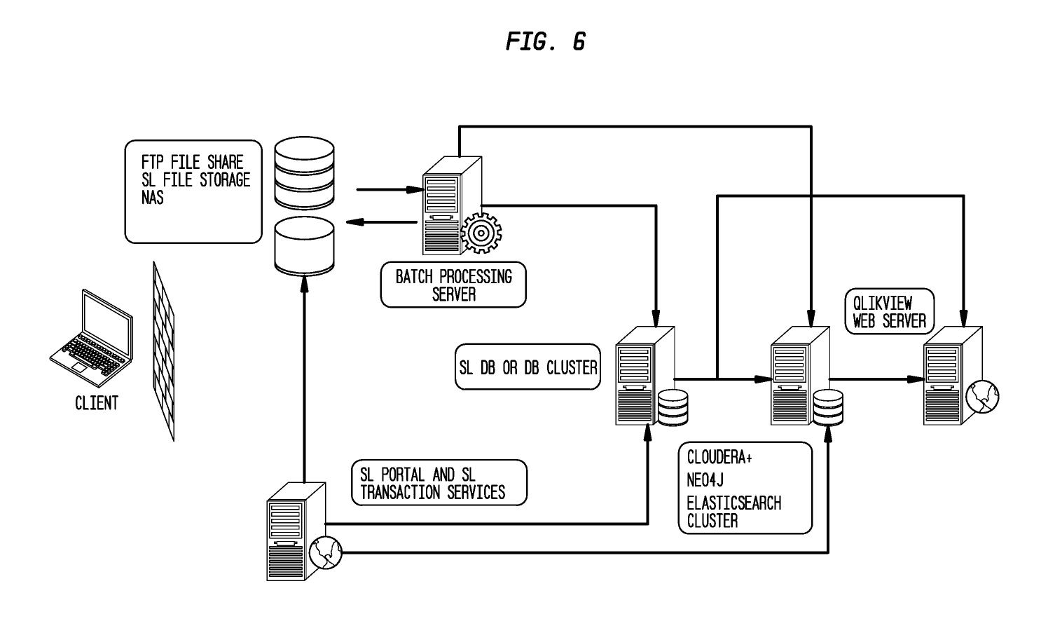

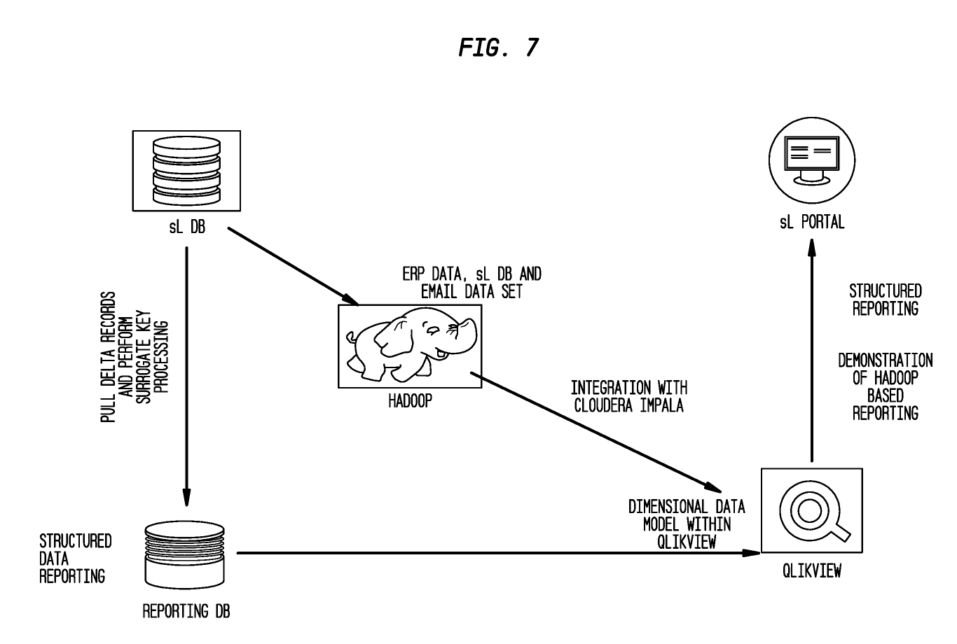

In embodiments of the present invention a due diligence module is provided to assess risks associated with business partners (BP). For example, a organization may face reputational risks when doing business with business partners. BP may have ties with governmental officials, may have been sanctioned, involved in government investigations for allegations of misconduct, significant litigations or adverse media attention. The due diligence module receives user input ranking the BPs based on high, medium and low risk using pre-determined attributes or parameters as designated by the user. The purpose of this module is to conduct reputational and financial reviews of BP's background and propose guidelines for doing business with vendors, suppliers, agents and customers. FIG. 5 depicts a due diligence process.

Based on the BP risk rankings as discussed above, three different types of due diligence are assigned to each BP. The three types of due diligence are based on the premise that the higher the risk, the associated due diligence should be broader and deeper. The different types of due diligence encompass the following activities:

Basic: Internet, media searches and review of documents provided by the BP (e.g., code of conduct, policies and procedures on compliance and governance, financial information). Plus: Basic+proprietary database and sanction list searches.
Premium:
Plus+on the ground inquiries/investigation (e.g., site visits, discrete inquiries, contacting business references). Each of the search results are tagged under the following categories: sanction lists, criminal investigation, negative media attention, litigation and other.

Transaction Monitoring and Email Monitoring Modules

Transaction Monitoring Module (TMM)

The TMM module is designed to perform continuous monitoring of business transaction data that are recorded in the subject organization's enterprise systems (e.g., Enterprise Resource Planning (ERP)); preferably, the application will run independently of the enterprise systems thus not hindering the performance of those systems. Transaction data is extracted through built-in connectors, normalized and then staged in the application database. Next, queries are run whereby the transactions are automatically flagged for further review if they violate pre-determined rules (rules engine) that are embedded in the software. These flagged transactions will be accessed by the appropriate individuals identified by the company for further review and audit based on probability scores assigned by the application (the process of assigning probability scores for each flagged transaction and the self-learning of the patterns of each transaction is discussed herein); they will be notified of exceptions, upon which they will log on to the application and follow a process to resolve the flagged transactions. Based on rules set up for the organization, holds may be placed on payment or the transaction flagged based on certain parameters or cleared without any further action.

Since the transactions and associated internal controls are reviewed simultaneously, the transaction monitoring module is linked with an internal controls module. The individuals in the organization assigned to review the transactions also simultaneously review the pre-defined internal controls to determine if any controls were violated.

Email Monitoring Module (EMM)

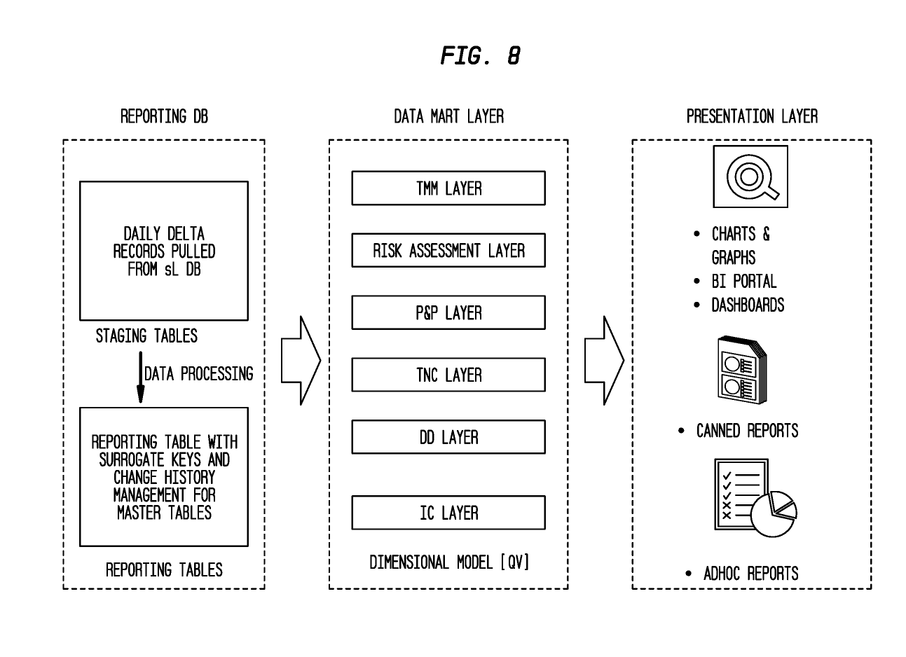

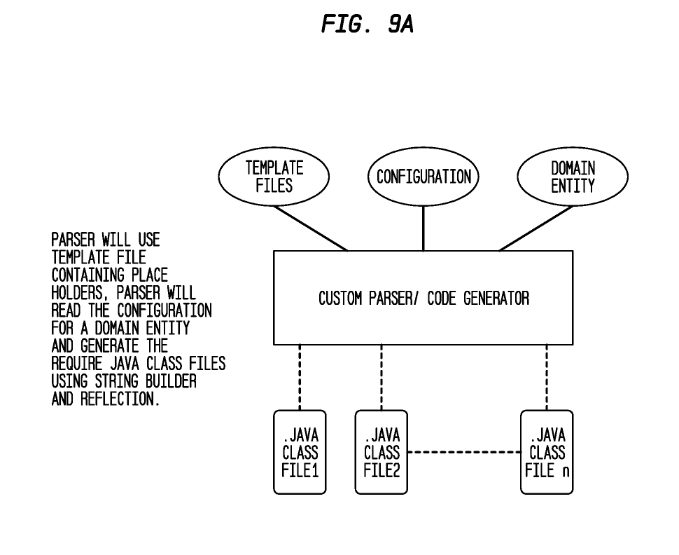

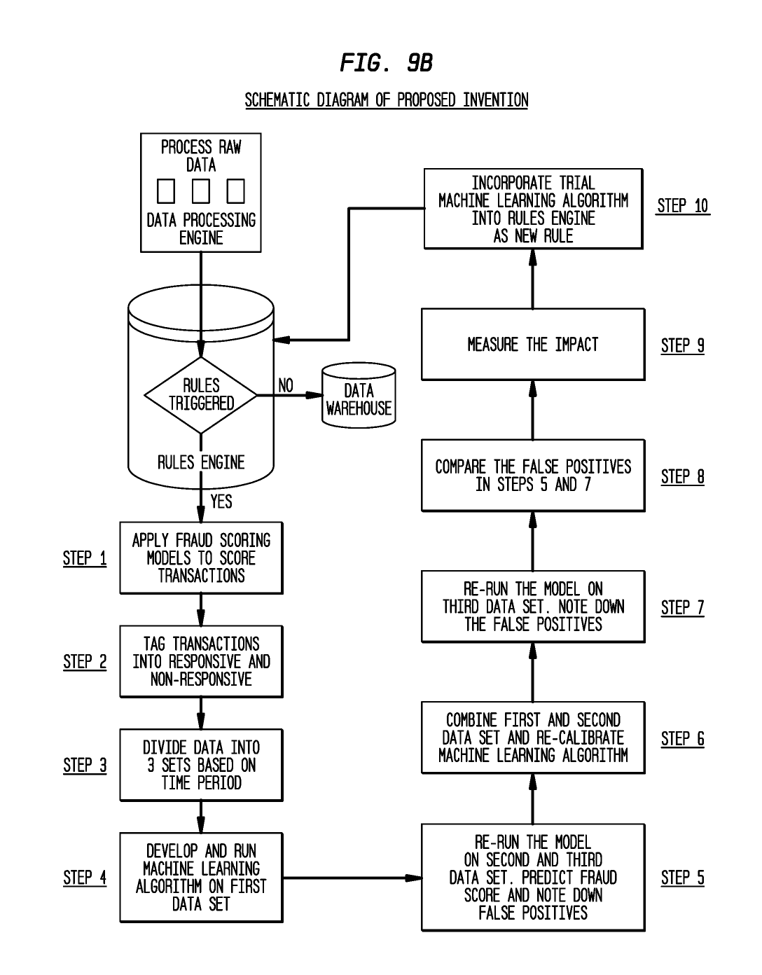

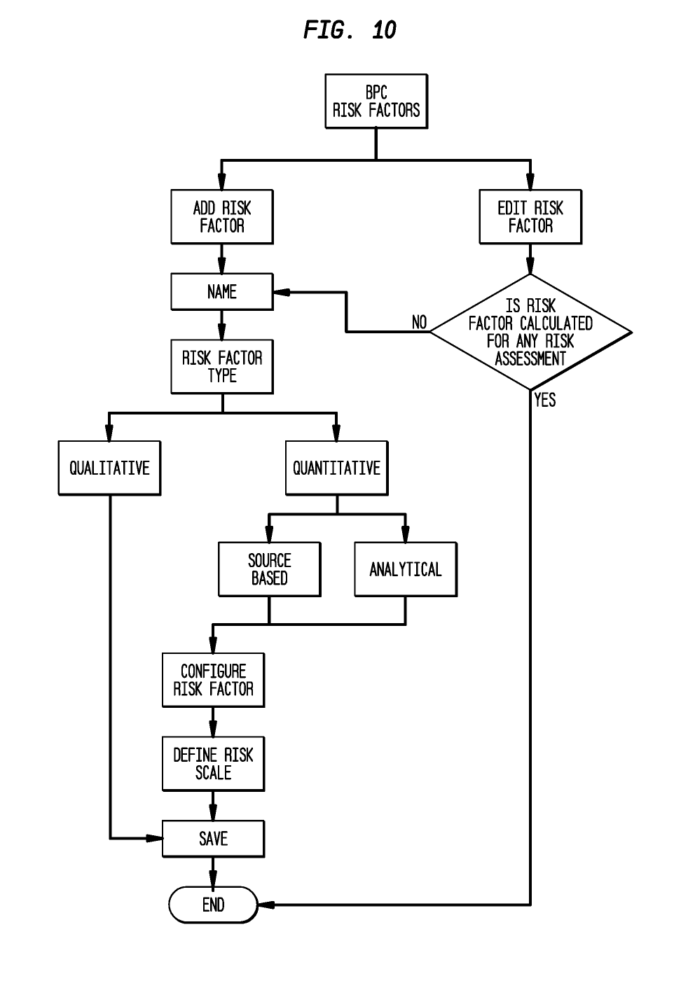

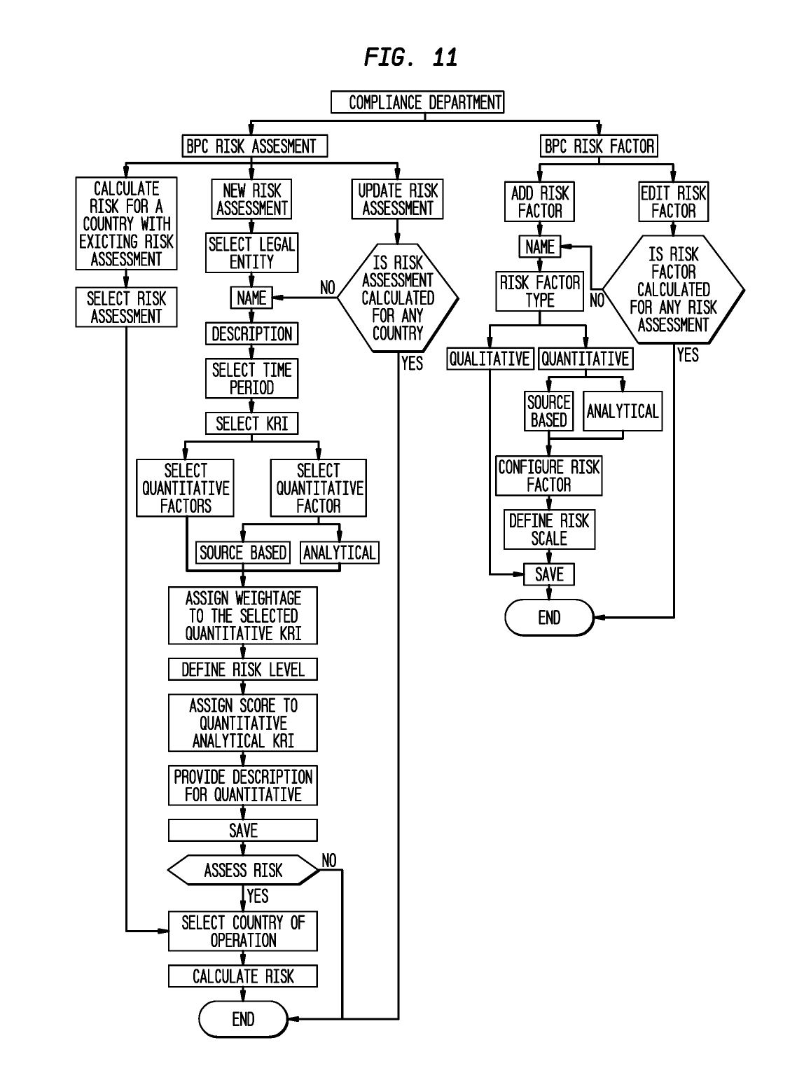

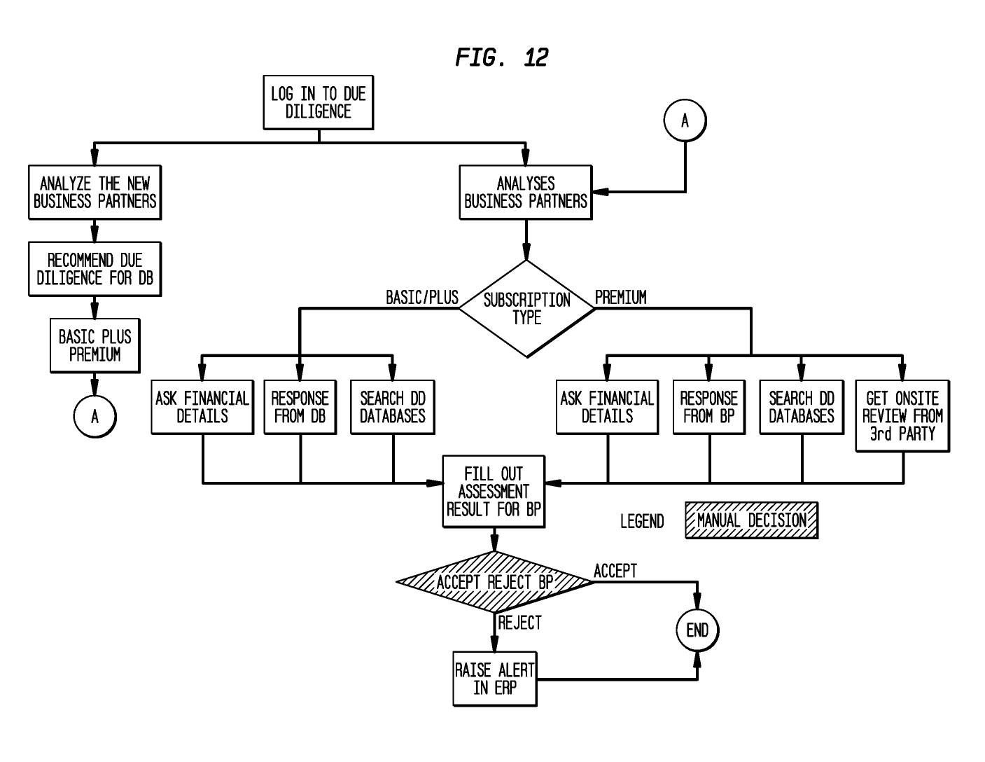

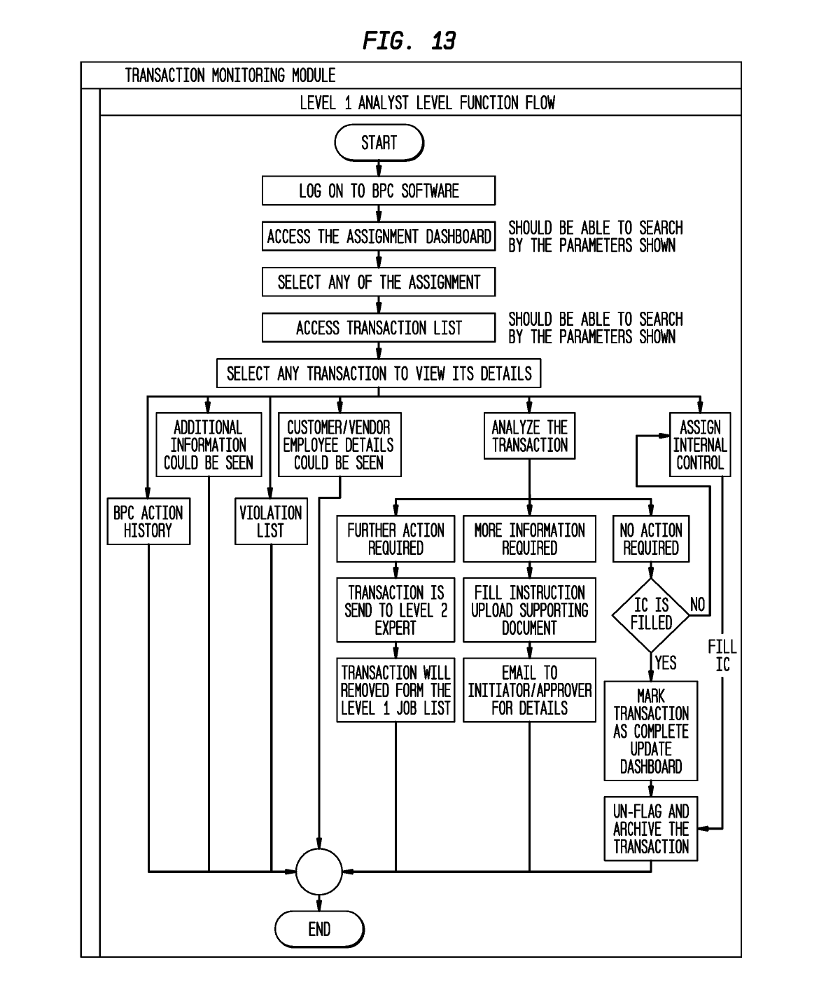

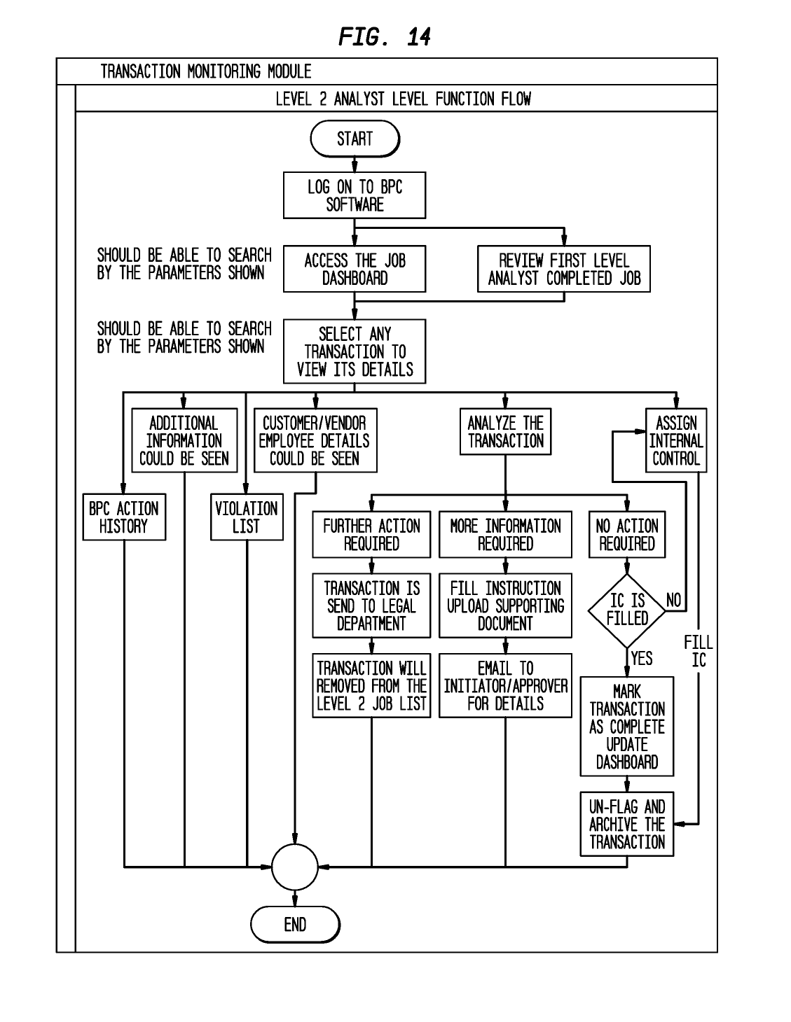

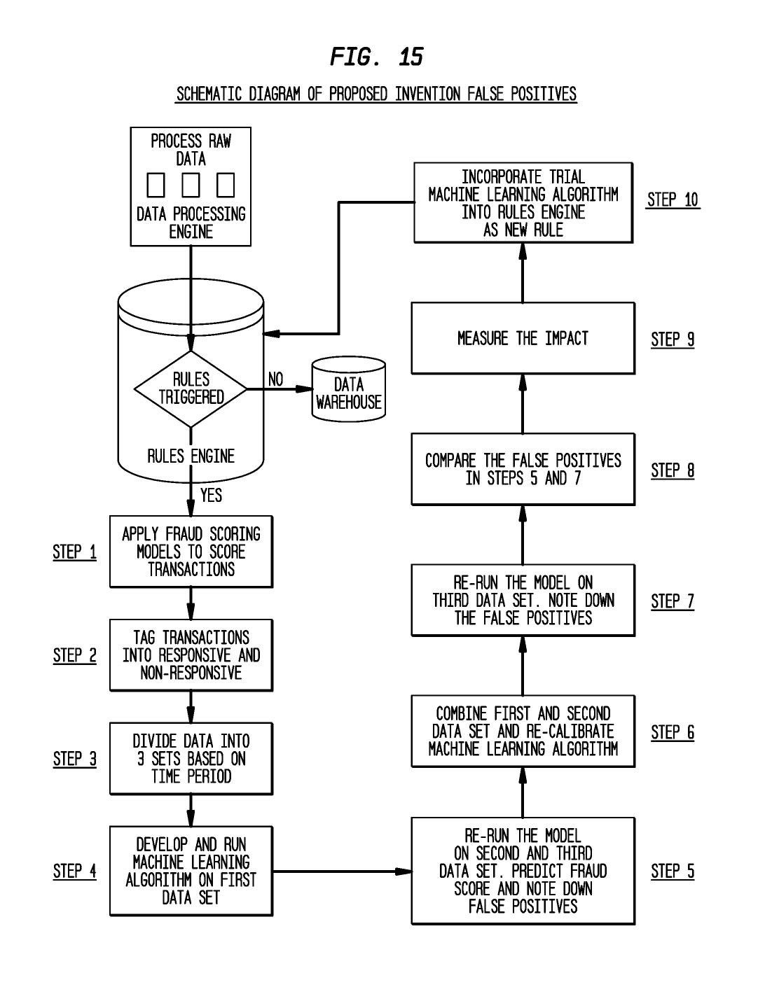

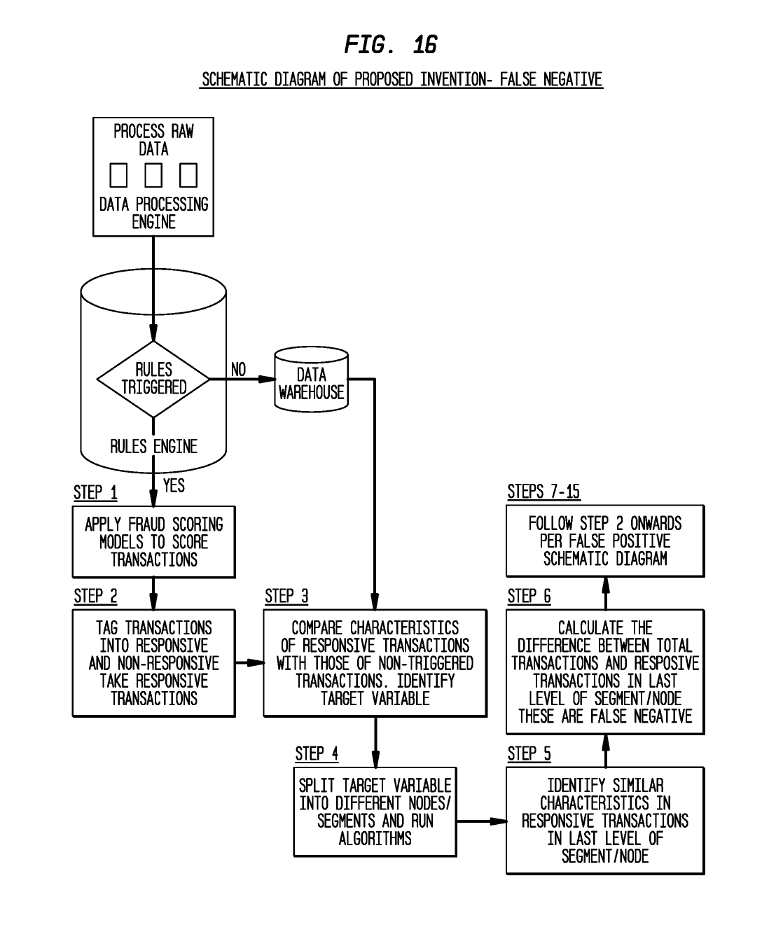

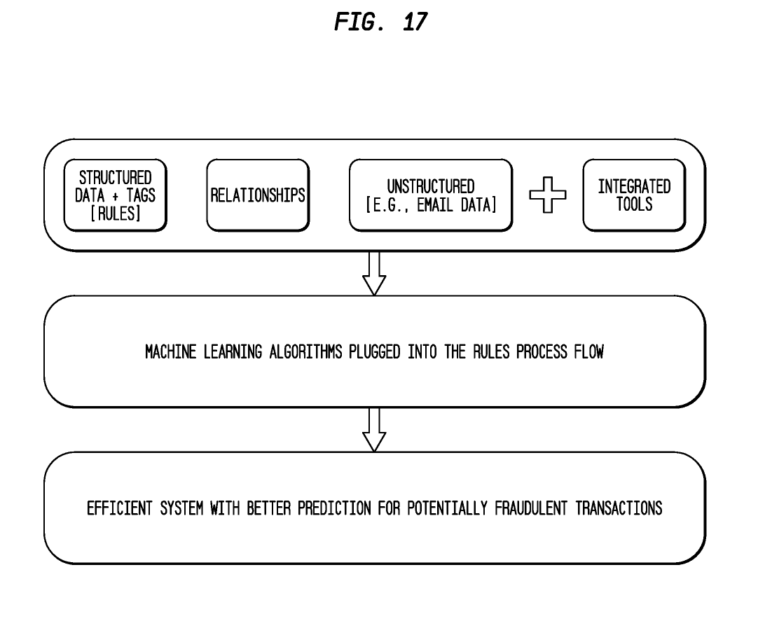

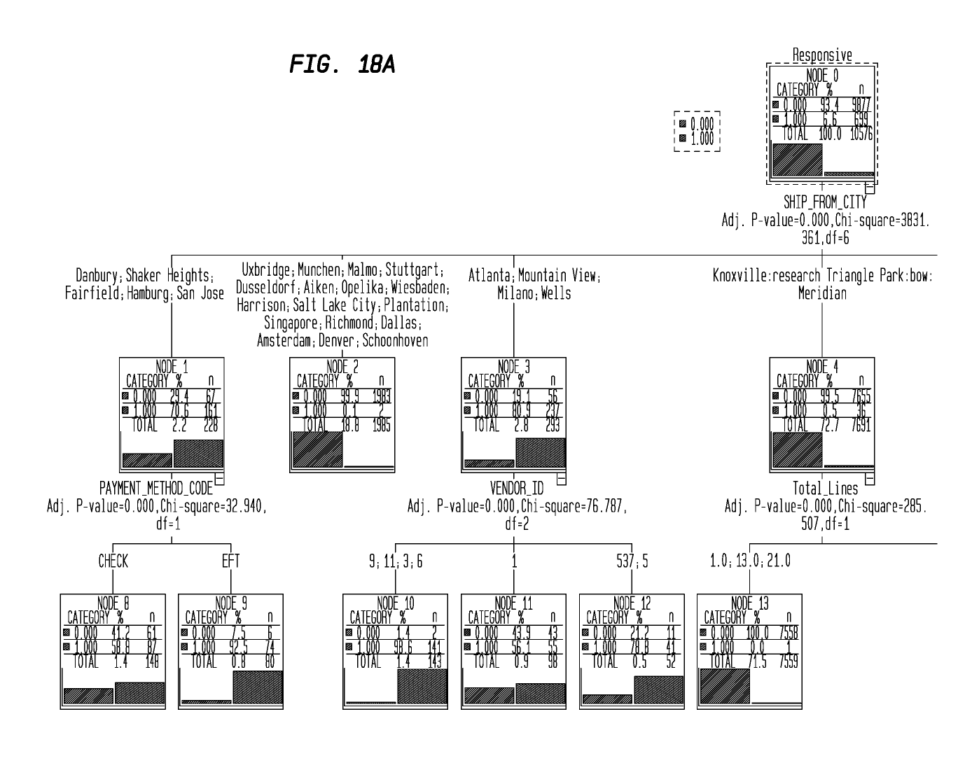

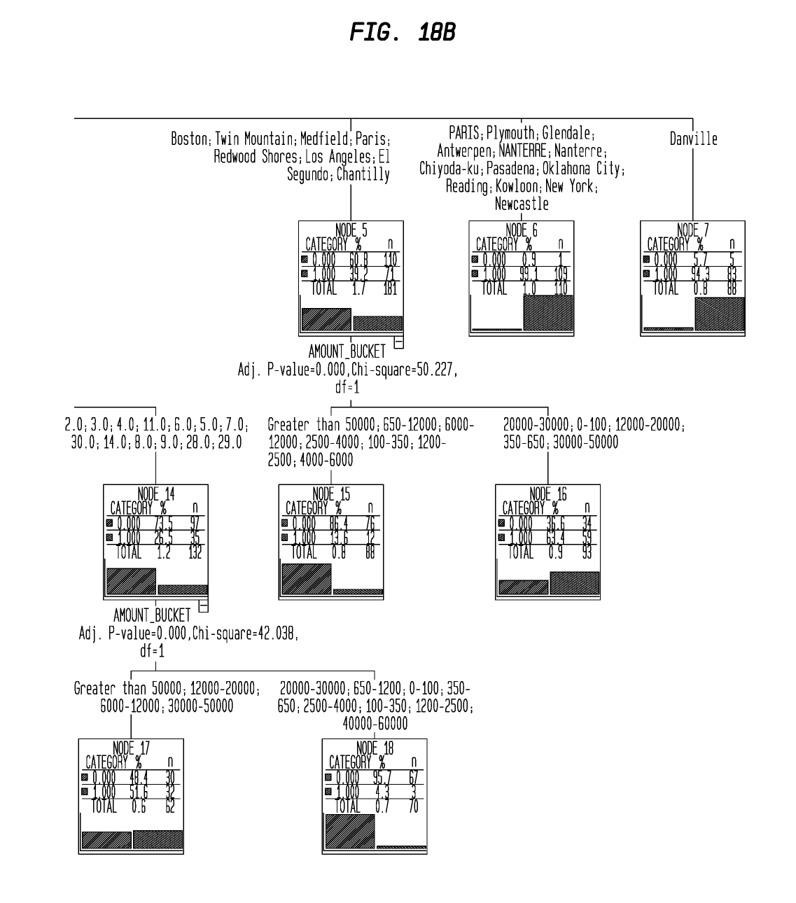

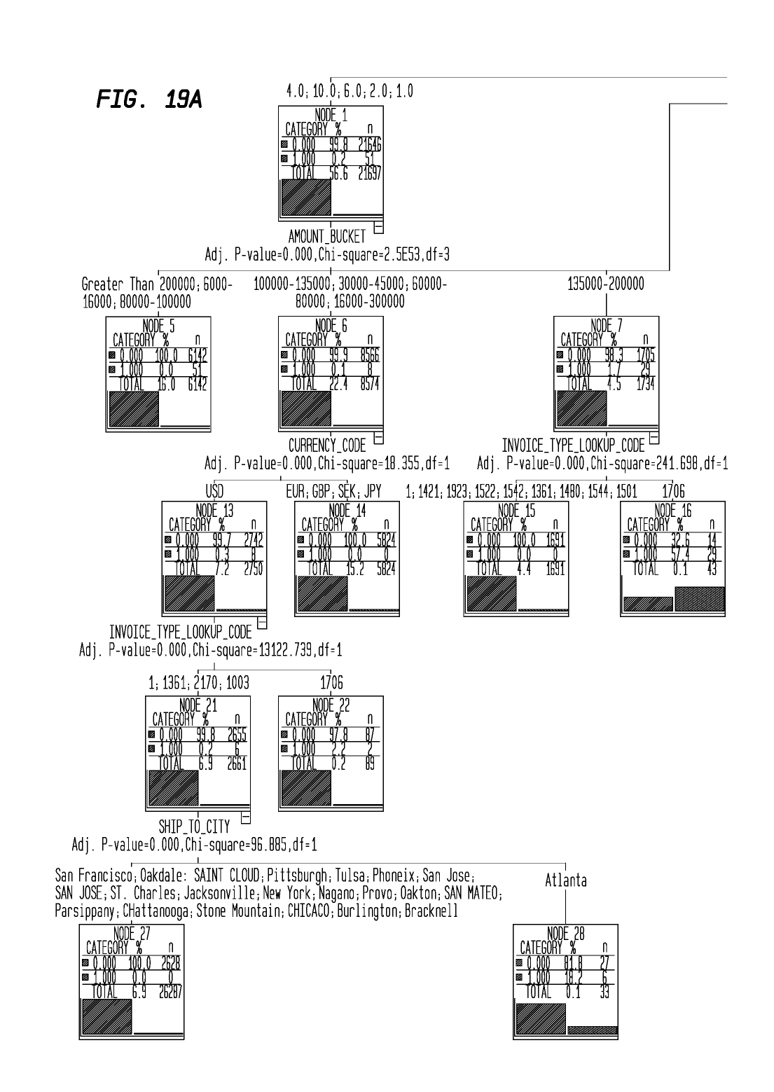

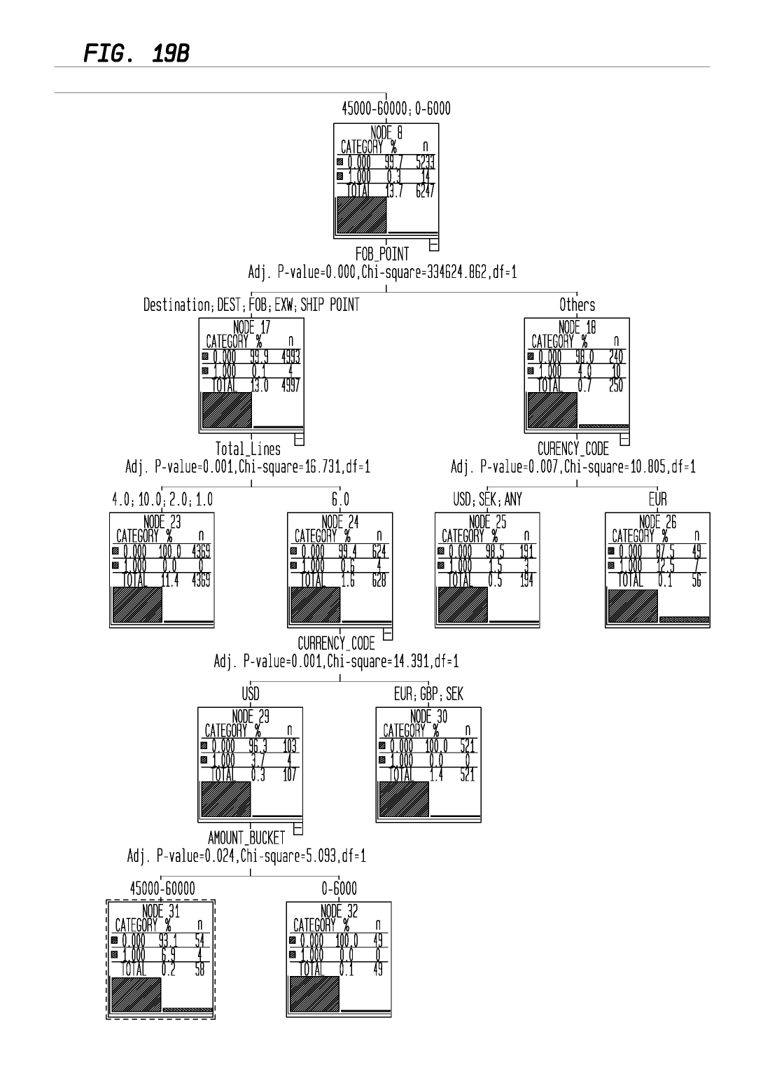

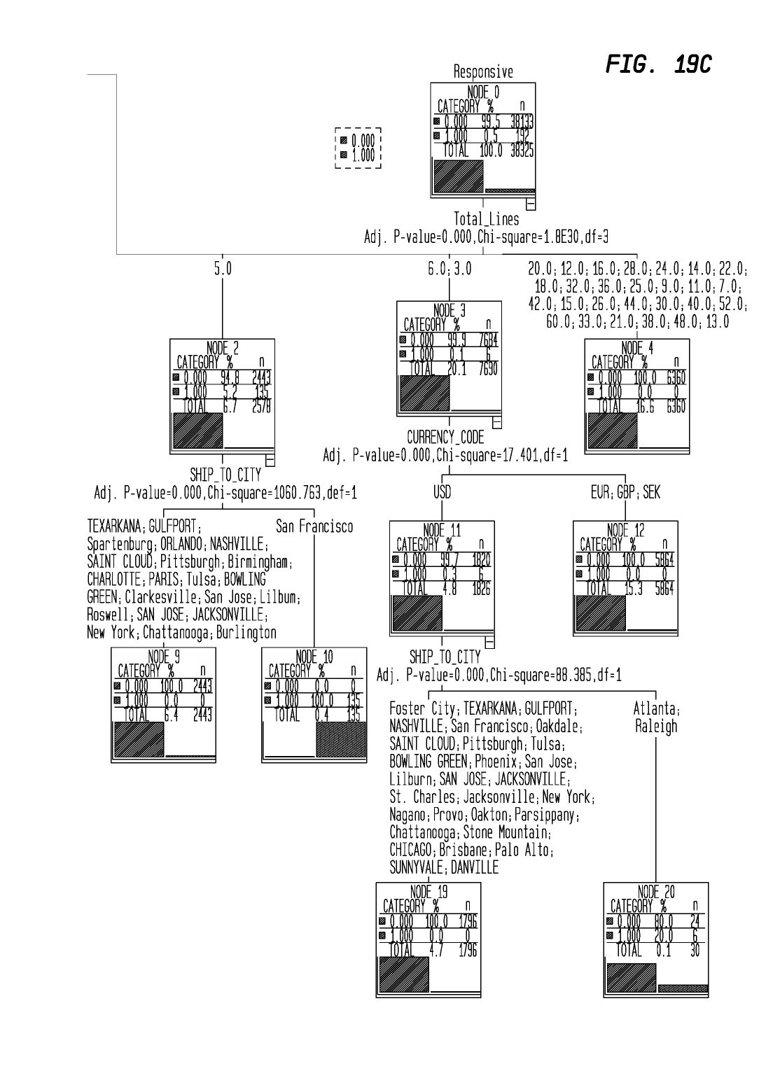

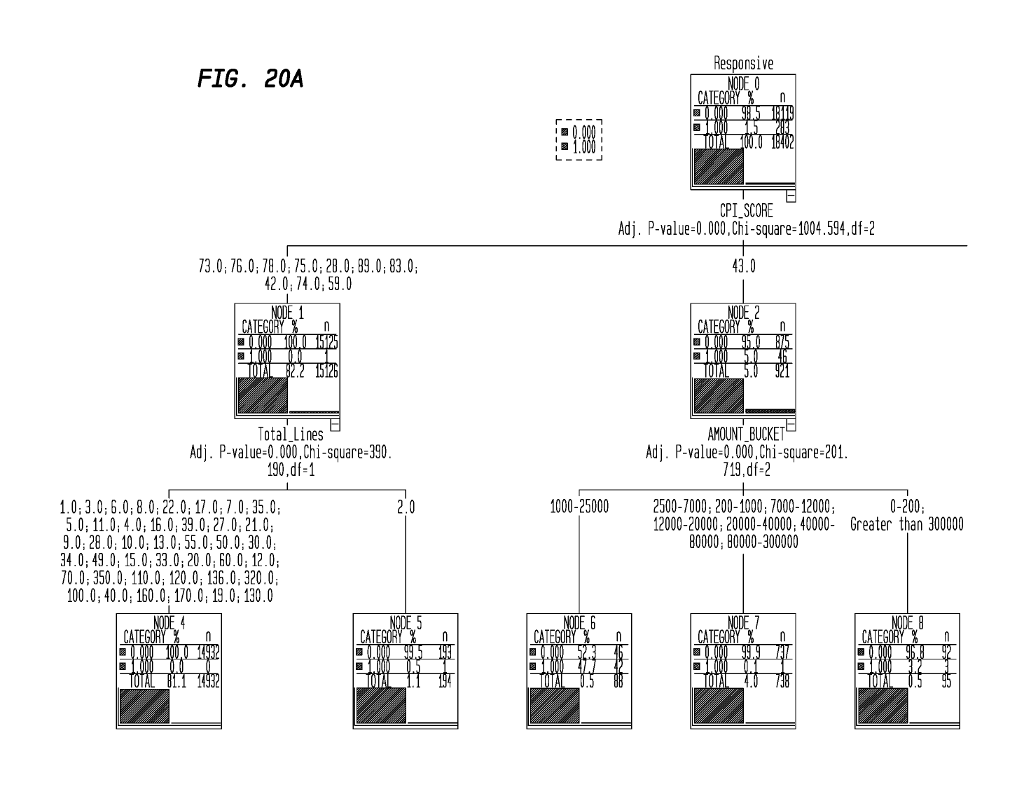

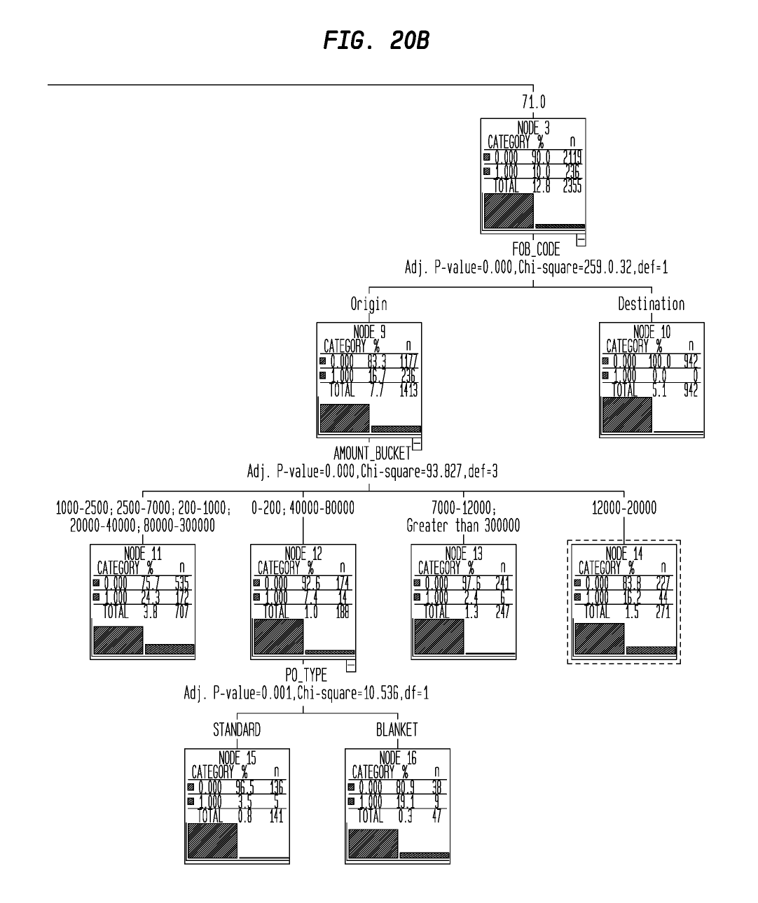

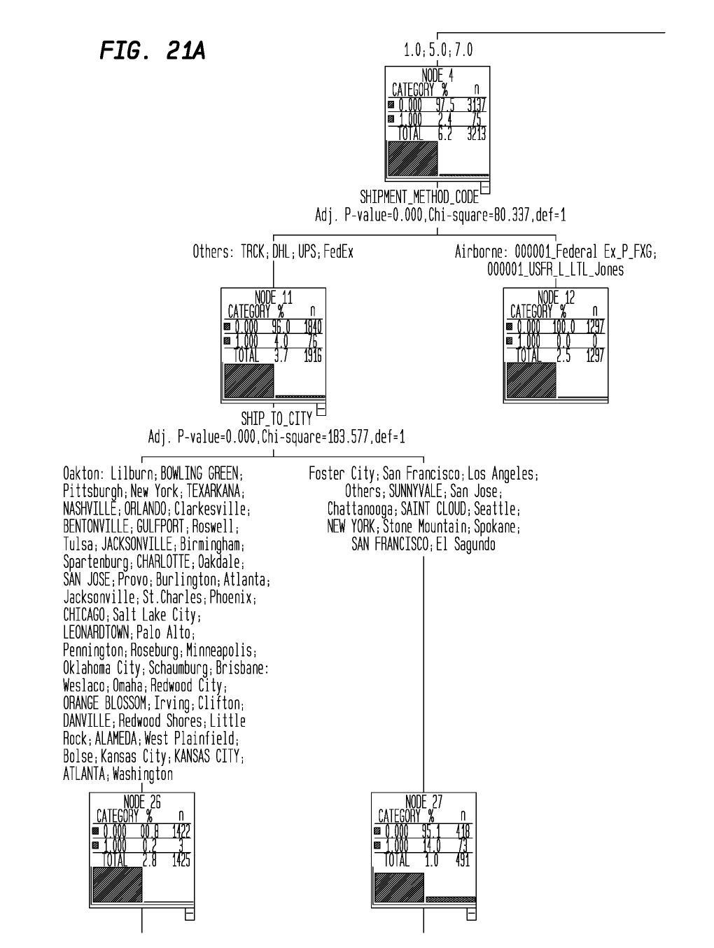

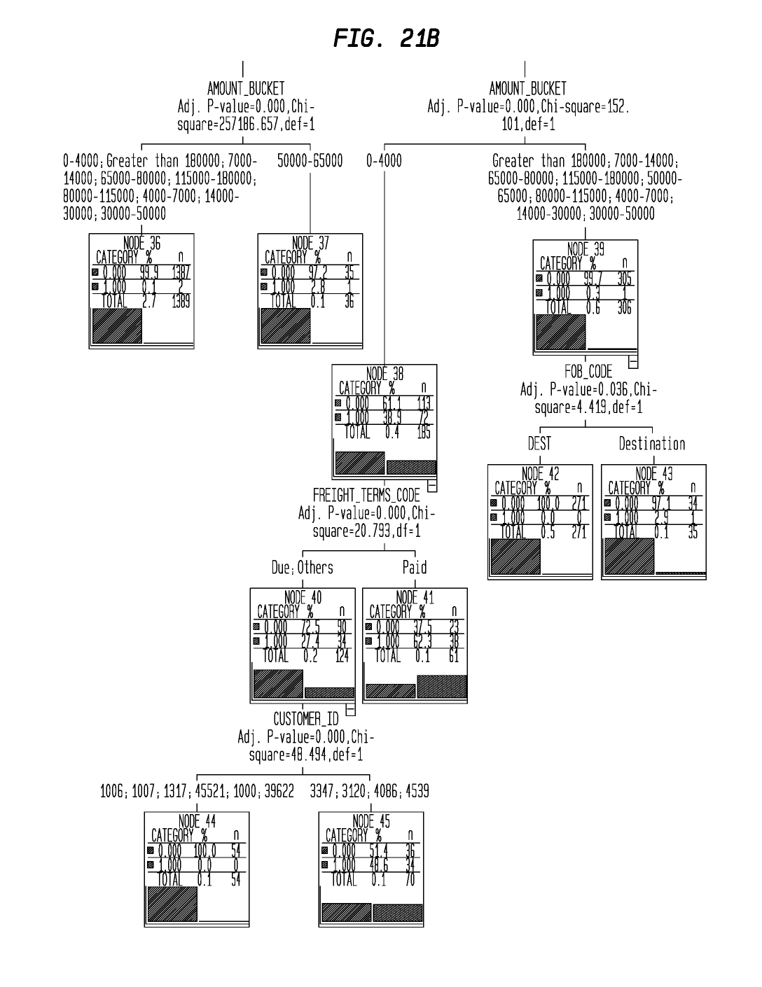

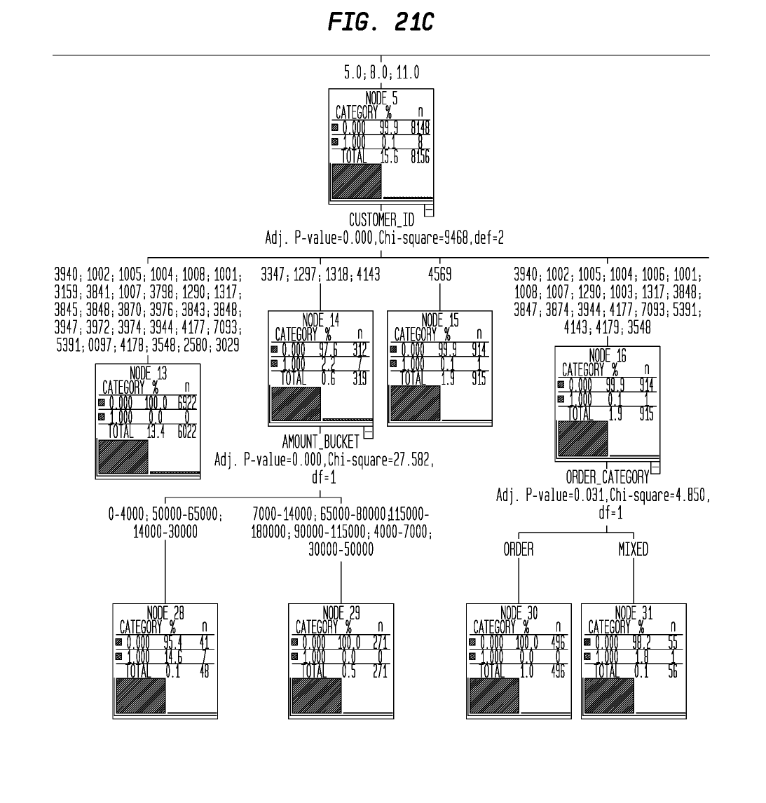

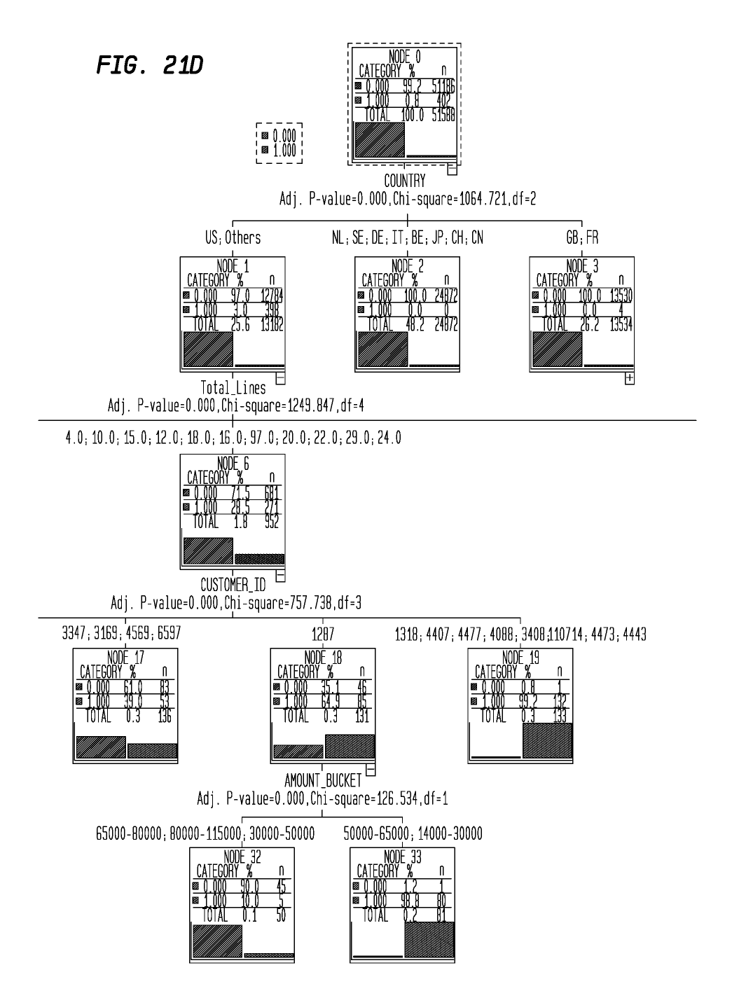

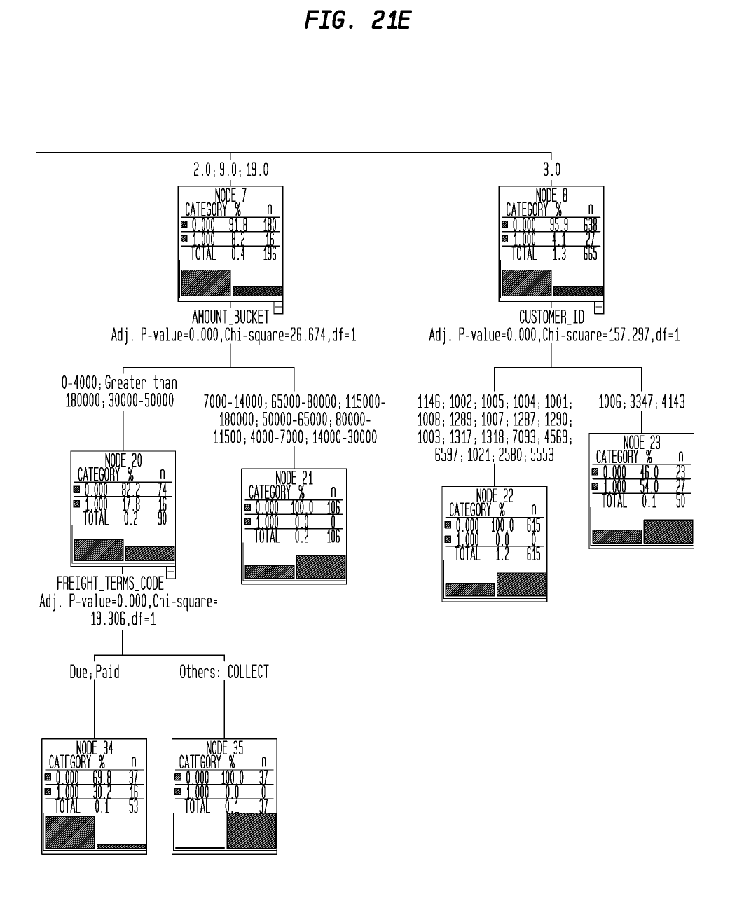

Referring now to FIG. 8 the EMM is a monitoring tool of enterprise emails that are flagged by predefined rules on the exchange email server. These emails are then be analyzed for any fraud related link. Though a particular transaction(s) may not be triggered by a rule, there could be some emails that would indicate a link to a possibly risky transaction.

The functionality of this module is based on certain concepts or terms that the client would like to monitor in employee emails on a go forward basis. These terms/concepts can be applicable for certain legal entity/location/department. The terms/concepts/key words should be initiated by someone at the level of manager in legal/compliance department.

All the emails flagged from the exchange server would be automatically blind copied (Bcc'd) to a defined email account in the application. An analyst would be able to view, check and act upon all these emails, including the ability to flag a transaction with an email.

Internal Controls Module

The purpose of the internal controls module is for the organization to be able to assess the design and operational effectiveness of its internal controls. The design effectiveness will be assessed at the beginning of a given period and operational effectiveness will be assessed at the time of transaction monitoring. This module is designed to have in one place a summary of all the internal control breakdowns that take place during the transaction cycle. This is important because even though a particular transaction(s) may not result in being fraudulent, there may be control breakdowns resulting from that transaction that the organization would need to address. The controls will then be analyzed in conjunction with the transactions' monitoring module (transactions that violate specific rules) in order to evaluate the severity of the violations.

### EXAMPLE 1

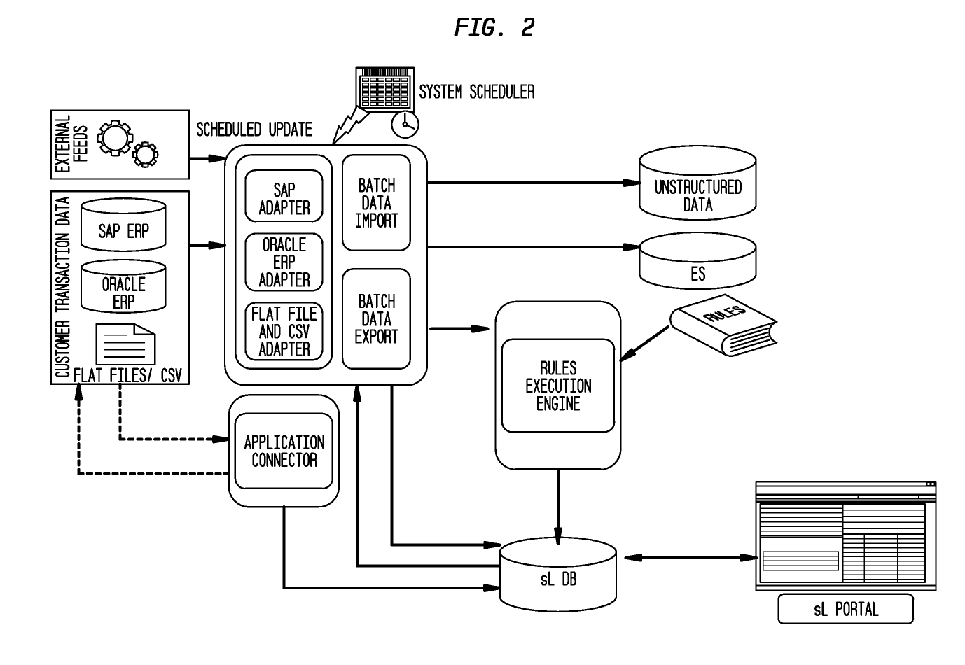

We now refer to an exemplary clustering modeling approach with data constraints where (i) Historical Risky Transactions are not available, (ii) Transactions tagging is not available, (iii) SHIP_TO and BILL_TO details in the AP data are not available and (iv) Purchase Order data is incomplete, referring also to FIG. 2. Considering the constraints mentioned above, the system analysis is restricted to AP Lines and assumes a few transaction clusters as Risky Variables available for analysis: GROSS_AMOUNT; SHIP_FROM_CITY; SHIP_FROM_COUNTRY; VENDOR_NAME; INVOICE_CURRENCY_CODE; PAYMENT_CURRENCY_CODE; PAYMENT_METHOD_CODE; INVOICE_TYPE_LOOKUP_CODE.

The modeling approach consolidates the AP Lines data and combines it with AP Header data to provide maximum possible variables for analysis. Clusters in the AP data based on the number of lines and amount distribution are created. Segmenting the transactions based on statistical analyses and tagging the transactions from few groups as risky ones then occurs. In this way, the data is tagged by creating a new variable called “Risky_Line_Transaction”. The model then assigns “Risky_Line_Transaction” as the dependent variable and other variables as independent variables. The data is split into two parts: 60% for training and 40% for validating the model. A self-learning classification algorithm called CHAID (Chi Square Automatic Interaction Detection) Decision Tree is applied to identify optimal patterns in the data related to Risky transactions. Once the accuracy of the model is validated new rules related to risky transactions are created.

Training & Validation Results (see diagram following discussion)

For Training data: Risky transactions are 3.8% (469) out of 12,281transactions

For Test data: Risky transactions detected in the test data are 4% (331) out of 8,195 transactions

TABLE 1

| | | | PRE- | | |
|---|---|---|---|---|---|
| | | | DICTED | | Percent |
| | | | 0 | 1 | Correct |
| Training | ACTUAL | 0 | 11707 | 105 | 99.10% |
| Data | | 1 | 203 | 266 | 56.70% |
| (60%) | | Overall | | | 97.50% |
| | | Accuracy | | | |
| | | Percentage | | | |
| Validation | ACTUAL | 0 | 7791 | 73 | 99.10% |
| Data | | 1 | 141 | 190 | 57.40% |
| (40%) | | Overall | | | 97.40% |
| | | Accuracy | | | |
| | | Percentage | | | |

Note:
Risky Transactions are denoted as 1 and Normal Transactions as 0.

Patterns to Identify Risky Transactions

If the Invoice line created from the Country IT/SE, from the City “Milano”/“Kiruna”, and Gross amount greater than 39600, then that transaction can be suspicious.

If the Invoice line created from the Country IT/SE, from the City “Stockholm”/“Landskrona”/“Falkenberg”, Gross amount greater than 39600 and With number of lines >4, then that transaction can be suspicious.

If the Invoice line created by the Vendor Name “Anne Hamilton”, Gross Amount between 245-594 and INVOICE_TYPE_LOOKUP_CODE as “Expense Support.”, then that transaction can be suspicious.

If the Invoice line created from the Country US/DE/HK, Currency as EUR/USD and for delivery in Spain, Gross amount greater than 39600 can be suspicious.

If the Invoice line created from the Country IT/SE, from the City Malm/Roma/Kista/Sundsvall/Gothenburg and Gross amount greater than 39600, then that transaction can be suspicious.

If the Invoice line created from the Country FR/GB and Gross amount greater than 39600, then that transaction can be suspicious.

If the Invoice line created from the City “Denver”, With number of lines >4, Gross amount greater than 245 and INVOICE_TYPE_LOOKUP_CODE as “Expense Support”, then that transaction can be suspicious.

The foregoing model can be accomplished by the following exemplary code:

Code Written in R Statistical Package

```
    # =======Importing Data==================
    =====================
    dat<-read.csv(“Risky_Tagged.csv”)
    dat$Risky<-
as.factor(dat$Risky)
# ====================Spliting of Data into 60 training Data - 40
  test data================================
    Normal_data<-dat[dat$Risk==0,]
    Risky_data<-
dat[dat$Risk==1,]
    # Training data
    Normal_train_data<-Normal_data[c(1:11465),]
    dim(Normal_train_data)
    Risky_train_data<-Sus_data[c(1:821),]
    train_data<-as.data.frame(rbind(Normal_train_data,Sus_train_data))
    #Testing Data
    Normal_test_data<-Normal_data[c(11466:19108),]
    Risky_test_data<-Sus_data[c(822:1368),]
    names(Normal_train_data)
    #==================Fitting the model==================
    rfit <-
  rpart(Risky~GROSS_AMOUNT+SHIP_FROM_COUNTRY,data =
  train_data,method=“class”)
    rpart.plot(rfit,type=3,extra=9,branch=0)
    names(rfit)
    write.csv(rfit$y,“Tree
reuslt.csv”) #=====
Model Validation
  ====================================================
    rtest<-predict(rfit,Normal_test_data)
    #===============================================
  ===========================================
==
  =========
```

TABLE 2

| Risk Factor | Categorization of Risk Factor |
|---|---|
| QUANTITATIVE | |
| FACTORS | |
| CPI Score of country | Low (1 point): 71-100; Medium (3 points): 51-70; High |
| for which risk | (6 points): 31-50; Very high (10 points): 0-30 |
| assessment is | |
| being performed. | |
| Revenues for operations | Low (1 point): $0-$1 million; Medium (3 points): $1,000,001- |
| | $10 m; High (6 points): $10,000,001-$50 million; Very high |
| | (10 points): >$50,000,001 |
| Sales model | Low (1 point X number of providers): vendor warehousing; |
| relationship with | other agents (e.g., rental), other vendors not part of medium or |
| government customers | high risk; Medium (5 points X number of providers): vendor- |
| | trading, resellers, suppliers, service providers-contractors; high |
| | (10 points X number of providers): sales agents, distributors, |
| | procurement vendors, service provider-logistics, freight |
| | forwarders, consultants |
| Nature of business | Low (1 point): Warehousing, trading; Medium (5 points): |
| operations | Manufacturing; High (10 points): sales |
| Government Interaction | Low (1 point): no government revenue; high (10 points): |
| (Interaction (direct/indirect) | government revenue |
| with governments-federal, | |
| state and local; government | |
| agencies; State-owned | |
| enterprises (SOEs); other | |
| government customers) | |
| Business Entity type | Low (1 point): Wholly owned subsidiary (consolidated |
| or Legal structure | financial statements); Medium (5 points): non-consolidated |
| | subsidiary, JV; High (10 points): partnership |

TABLE 3

| No. | Rule Name | Rule Description |
|---|---|---|
| 1 | Structured Payment | Transaction involving structured payments (e.g. split to |
| | | multiple bank accounts or different payees or made in |
| | | an amount designed to avoid an approval threshold) |
| | | Identify cumulative Payments for two or more transactions |
| | | approved by same Employee to the same Vendor that exceeds |
| | | or is within (XX Standard Deviations) or a Percentage Below |
| | | Threshold of the Authority Limit. |
| 2 | Non-working day | Transaction date is on weekends or holidays or non-working day. |
| 3A | Unapproved entity | Transaction with entity (including narrative of transaction) |
| | | appearing on “Do Not Use/Do Not Pay” or “Inactive” lists |
| 3B | OFAC | Non FCPA Sen. Transaction with entity (including narrative of |
| | | transaction) appearing on OFAC Specially Designated Nationals |
| | | list (including identical and similar names) |
| 3C | PEPs | Non FCPA Sen. Transaction with entity (including narrative |
| | | of transaction) appearing on Politically Exposed Persons list |
| | | (including identical and similar names) |
| 3D | Unknown Entity | Transaction with entity not appearing on “Vendor Master |
| | | File”/“Employee Master File”/“Customer Master File” |
| 4 | No Description | Transaction OR journal entries without associated |
| | | transaction narrative/description |
| 5 | Duplicate Doc. No. | Transactions with duplicate document numbers in the same |
| | | fiscal year (e.g. invoice number; expense report number etc.) |
| 6 | Exceeding Limit | Transaction amount equal to or exceeding approver limit |
| 7 | Keyword Match | Transaction narrative responsive to keyword search |
| 7A | Suspicious Term(s) | Transactions containing terms associated bribery and corruption |
| 8 | Missing Names | Transaction with blank entity name |
| 9 | No Entity Status | Transaction with entity without designated status value (e.g. |
| | | active, inactive, etc.) on Vendor/Customer Master files |
| 10 | Initiate = Approv | Transaction initiated/submitted and approved by the same individual |
| 11 | Cash/Bearer Pymnt. | Payment by check made out to “cash” or “bearer” or |
| | | [company equivalent] |
| 12 | Vendor = Customer | Transaction with entity appearing on “Vendor Master File” |
| | | AND “Customer Master File” |
| 13 | Sequential | Transactions with an entity with sequential document numbers |
| | | (e.g.i nvoice number; return invoice number, credit memo etc.) |
| 14 | Unusual Sequence | Transaction with generic assigned document number (e.g. 9999 |
| | | or illogical sequence based on date or characters for field type) |
| | | (note: determine frequency and examine top 10 instances) |
| 15 | Duplicate Trans. Amnt. | Duplicate transaction amounts (less than 10 days apart) for an |
| | | entity (note: subject to review of organization's business activity; |
| | | excluding certain ledger activity e.g. rent or lease etc.) |
| 16 | Trans. Amnt. Threshold | Transaction OR payment Amount exceeding [XX standard |
| | | deviation] of the average total monthly/quarterly/yearly |
| | | account activity. |
| 17 | Entity = Employee | Transaction with third party entity with address matching an |
| | | employee's address or telephone number or tax ID |
| 18A | Exceed Credit Limit | Customer with accounts receivable activity |
| | | exceeding credit limit. |
| 18B | AR Variance | Customer with accounts receivable activity that has significant |
| | | positive or negative spikes (percentage variance over average |
| | | outstanding accounts receivable balance for [XX period]) |
| 19A | Excessive CN | Customer with negative sales or significant returns [XX percentage] |
| | | in a quarter/year over (excessive credit note activity) |
| 19B | Unusual CN_No Explain | Credit notes that are offered with no explanation |
| 19C | Unusual CN-Discount | Credit notes that are offered as a discount |
| 20 | Diff Ship Addrs | Order that is shipped to location other than customer's or designated |
| | | recipient's address |
| 21 | Unusual Pymnt. Term | Payment terms exceeding [XX days] |
| 22 | Qty Ship > Order Amnt. | Product shipped quantity exceeding sales order quantity |
| 23 | Vendor Debit Bal. | Vendors with debit (A/P) balance |
| 24 | Round Trans. Amnt. | Round transaction amount |
| 25 | Similar Entities | Transactions with multiple entities with same information |
| 26 | Foreign Bank Acct. | Transaction with payment to foreign country bank account when |
| | | compared to country of address of the vendor |
| 27 | Missing Entity Info. | Transaction with entity without information in any master file |
| 28 | C/O Addrs | Transaction with entity address containing “care of,” “C/O” |
| 29 | PO Box Addrs | Transaction with entity with PO Box address only (no physical |
| | | address in any master file) |
| 30 | Alt. Payee Name | Transaction with vendors where alternate payee names have |
| | | been flip-flopped within XX days |
| 31 | One Time Vendor | Transaction with entity receiving one-time |
| | | payment [over XX amount] [over XX period] |
| 32 | Alt. Bank Acct. | Transaction with vendors where bank accounts have been |
| | | flip-flopped within XX days |
| 33 | Diff. Pymnt. Method | Payment methods different from Company's/entity's ordinary |
| | | course of business (e.g. check or cash vs. wire; advance |
| | | payment vs. payment upon completion/delivery of |
| | | services/products) |
| 34 | Trans = Interco | Transaction amounts of $5,000 matching amount of |
| | | intercompany transfer |
| 35 | Date Mismatch | Transaction date preceding document date (e.g. invoice date; |
| | Trans/Doc Date | expense report date etc.) |
| 36 | Generic ID | Transaction with entity with generic identifier or illogical |
| | | characters given field type or standards (e.g. characters |
| | | in numeric fields) |
| 37 | Free of Charge Rtrn. | Goods return credit note with a non-zero value issued for |
| | | products that were initially shipped free of charge |
| 38 | Sales Return Delay | Time lag exceeding [XX period] between entity's initial purchase |
| | | of products and associated credit note for return of goods |
| 39 | Trans. Mismatch | Transaction appearing in (accounting system) and not in |
| | | (customer order entry system) and vice versa |
| 40 | Missing P&L Acct. | Transaction not recorded in a Profit & Loss account, but in a |
| | | Balance Sheet code (transactions either reducing cash, prepaid |
| | | expenses, deposits or notes receivable or increasing accounts |
| | | payable balance) |
| 41 | No Serv./Prdct. | Transaction for service/product not rendered |
| 42 | Unusual Shipments | Sales order associated with duplicate/multiple product |
| | | shipments over [XX consecutive months] |
| 43A | Neg. Margins | Sales transaction attributing to negative margin |
| 43B | Unusual Margins | Transaction with a margin exceeding [XX standard deviation] |
| | | of the average margin for that product. |
| 44 | Missing BU | Transaction not allocated to a business unit |
| 45 | No Cost Value | Sale/revenue transaction without underlying cost value |
| 46 | Period End Sales | Transactions within 5-days of quarter/year end in excess |
| | | of [XX standard deviation] of the average transaction amount |
| | | over [XX period] |
| 47 | Mismatch Foreign Curr. | Transaction in currency other than base currency of the |
| | | Company/location |
| 48 | Inconsistent GL Code | Transaction recorded to general ledger account that is |
| | | inconsistent with historical coding |
| 49 | Pymnt Date = Recpt | Payment date or receipt date is the same as the invoice date or other |
| | Date | document date (e.g. PO date) |
| 50 | Date Mismatch- | Transaction document date (e.g. invoice date) preceding |
| | Doc/Serv. | goods received/services rendered date |
| 51 | FMV | Transaction amount exceeding (XX standard deviations) of fair |
| | | market value of services/products rendered by the same provider |
| | | over [XX period] |
| 52A | Inv. Amnt. > PO Amnt. | Transaction with invoice amount exceeding purchase order amount |
| 52B | Payment Amount > Inv. | Transaction with payment amount exceeding invoice or purchase |
| | Amnt or PO Amnt. | order amount |
| 52C | Inv. Recpt > Goods | Identify Invoices where the invoice receipt amount is greater |
| | Recpt. | than the Goods Receipt amount. |
| 53 | Date Mismatch-Trans/PO | Transaction with transaction and/or invoice date preceding |
| | | purchase order date |
| 54 | Sales BackOrder | Backorder fulfillment within 5-days of quarter/year end |
| 55 | Unusual Discounts | Entity receiving above-market discount on services/products or sale |
| | | value is below (XX Standard Deviations) of fair market value of |
| | | services/products rendered [over XX period] |
| 56 | Non Std. Codes | Service/product stock/inventory codes that are not standard Company |
| | | stock codes |
| 57 | Emp-Adv 1 | Transaction with employee with outstanding temporary/perpetual |
| | | advance |
| 58 | Emp-Adv 2 | Employee with multiple temporary/perpetual advances outstanding at |
| | | the same time |
| 59 | Emp-Adv 3 | Employee with temporary advance balance outstanding longer than |
| | | [XX period] |
| 60 | Emp-Adv 4 | Employee with temporary/perpetual balance exceeding [XX amount] |
| 61 | Manual Override | Transaction with manual override |
| 62 | Inconsistent Purchase | Entity purchasing service/product that is inconsistent with historical |
| | | purchasing pattern |
| 63 | Expense Acct. Mismatch | Entity type does not match the underlying expense category used to |
| | | record the transaction (applicable when company has specifically |
| | | defined entity types) |
| 64 | Missing Contract No. | Transaction without associated/not assigned to contract or purchase |
| | | order |
| 65 | Missing Delivery Info. | Transaction with no third-party shipment/delivery provider identified |
| 66 | Emp = Gov't | Salary/compensation paid by HR/payroll function to third parties who |
| | | are or are affiliated with government agencies or to fictitious |
| | | employees with the purpose of paying a governmental entity. |
| 67 | Address Mismatch | Transactions with entity where the third party's address on the |
| | | PO/invoice or other documents is different from third party's address |
| | | contained in vendor/customer master file or the address previously |
| | | used for that third party. |
| 68 | Transport | Transaction recorded/related to transport of goods across borders |
| | | requiring logistics. Payments made to logistics providers. |
| 69 | Lic. & Permits | Transactions related to the payment of fees for licenses and permits |
| | | directly to government offices. |
| 70A | Char. Donat. | Transaction recorded/related to charitable contributions |
| 70B | Char. Donat.-Free Goods | Transaction recorded/related to charitable contributions in which free |
| | | goods are provided. |
| 71A | Political Contrib. | Transaction recorded/related to contributions to political parties |
| 71B | Political Contrib.- | Political contributions in which free goods are provided. |
| | Free Goods | |
| 72A | Sponsorship | Transaction recorded/related to sponsorships |
| 72B | Sponsorship-Free Goods | Sponsorships in which free goods are provided. |
| 73 | Facilitate Pymnt. | Transaction recorded/related to “facilitation payments” |
| 74A | Gifts-Multiple | Multiple gift transactions to a single recipient |
| 74B | Gifts-Exceed Policy | Gifts greater than allowable policy limits |
| 74C | Gifts-Exceed Approval | Gifts greater than approval thresholds |
| 75 | Incentives | Transaction recorded/related to incentives provided to third parties |
| 76 | Training & Seminars | Transaction recorded/related to expenses for attending training or |
| | | seminars or education by government officials |
| 77 | Tender Exp. | Transaction recorded/related to tender offers to government |
| | | customers |
| 78 | Cash Adv. | Transaction recorded/related to cash advances provided to |
| | | employees or third parties. |
| 79 | Petty Cash | Transaction recorded/related to petty cash provided to third parties |
| 80A | Samples-Exceed Policy | Samples greater than allowable policy limits |
| 80B | Samples-Approval | Samples greater than approval thresholds |
| 81 | Work Visas | Transaction recorded/related to work visas |
| 82A | Agents | Transaction recorded/related to Agents. |
| 82B | Consultants | Transaction recorded/related to consultants. |
| 82C | Distributors | Transaction recorded/related to distributors. |
| 83 | Commissions | Transaction recorded/related to commissions paid to distributors |
| | | or other customers. |
| 84 | AR Write-off-Excess | Transactions where an AR balance above a threshold has been |
| | | written off |
| 85 | AR Write-off-No Approval | Transactions where an AR balance has been written off with no |
| | | approval |
| 86 | Zero Value Invoices | Transactions with zero dollar amounts in the total invoice OR |
| | | in the invoice line amount. |
| 87 | No Amnt. | Transaction with no dollar amount. |
| 88 | Date Reverse | Transactions where the sequence of the date does not match the |
| | | sequence of the document number. For example, Invoice No. 1 is |
| | | dated May 1 and invoice no. 2 is dated April 15. |
| | | This should be checked for three business days. |
| 89A | Rmbrsmnt-Exceed | Expense reimbursements greater than allowable policy limits |
| | Policy | |
| 89B | Rmbrsmnt-Exceed | Expense reimbursements greater than approval thresholds |
| | Approval | |
| 90 | Rmbrsmnt-Exceed | Expense reimbursements greater than amount requested |
| | Amount | |
| 91 | AP Journal Entries | Debits and credits to AP account via stand-alone journal entries |
| 92 | Mismatch-Name | AP transactions where the Payee name is different than the name |
| | | on the Invoice |
| 93 | Rmbrsmnt-Even Trans. | Employees with more than a defined number of even-dollar cash |
| | Amount | expense transactions above a specific amount threshold in a |
| | | specified time period |
| 94 | Unauthorized Change | Vendors with master data changes created and/or approved by |
| | | an unauthorized employee. |
| 95 | Open Prepayments | Pre payments not applied to any invoice |

While it is apparent that the invention herein disclosed is well calculated to fulfill the objects, aspects, examples and embodiments above stated, it will be appreciated that numerous modifications and embodiments may be devised by those skilled in the art. It is intended that the appended claims cover all such modifications and embodiments as fall within the true spirit and scope of the present invention.

1. A system comprising:
at least one network connected server having risk assessment; due diligence; transaction and email monitoring; internal controls; investigations case management; policies and procedures;
training and certification; and reporting modules;
wherein said modules have risk algorithms or rules that identify potential organizational fraud;
wherein said system applies a scoring model to process transactions by scoring them and sidelines potential fraudulent transactions for reporting or further processing; and
wherein said further processing of potential fraudulent transactions comprises reducing false positives by scoring them via a second scoring model and sidelining those potential fraudulent transactions which meet a predetermined threshold value.

2. The system of claim 1 wherein said processing occurs iteratively and said system recalibrates the risk algorithms or rules underlying the scores over time.

4. The system of claim 1 wherein said sidelined transactions are autonomously processed by a similarity matching algorithm.

5. The system of claim 4 wherein a transaction may be manually cleared as a false positive and wherein similar transactions to those manually cleared as a false positive are automatically given the benefit of the prior clearance.

6. The system of claim 5 wherein less benefit is automatically accorded to said similar transactions with the passage of time.

7. The system of claim 1 wherein the scoring models are created using supervised machine learning.
